(19) United States
(12) Patent Application Publication
(10) Pub. No.: US 2025/0376024 A1
(43) Pub. Date: Dec. 11, 2025

(54) VEHICLE USER DETECTION DEVICE AND METHOD USING TOUCH SIGNAL

(71) Applicant: G2TOUCH Co., LTD., Seongnam-si (KR)

(72) Inventor: Dong Won YUN, Seongnam-si (KR)

(21) Appl. No.: 19/174,874

(22) Filed: Apr. 9, 2025

(30) Foreign Application Priority Data
Jun. 11, 2024 (KR) 10-2024-0075508

(51) Int. Cl. B60K 35/10; G06F 3/041

(52) U.S. Cl. CPC B60K 35/10; G06F 3/04166; B60K 2360/1438; B60K 2360/1468; B60K 2360/195

(57) ABSTRACT

Disclosed is a vehicle user detection device and method using a touch signal to distinguish a user of an in-vehicle touch display without any additional devices. The vehicle user detection device and method using a touch signal allow a touch display to be accessed only by a driver, thereby promoting safe driving.

### CROSS-REFERENCE TO RELATED APPLICATION

The present application claims the benefit of the filing date of Korean Patent Application No. 10-2024-0075508, filed Jun. 11, 2024, the disclosure of which is hereby incorporated herein by reference.

### TECHNICAL FIELD

Embodiments of the present disclosure relate to a vehicle user detection device and method using a touch signal to distinguish a user of an in-vehicle touch display.

### BACKGROUND

In recent years, a vehicular touch display including an infotainment system or other control functions is provided in a vehicle and plays an important role in driving of the vehicle.

A function of such a touch display is closely related to vehicle safety and tampering with driver's personal settings of the touch display through arbitrary manipulation by a passenger can cause confusion and distraction of the driver.

Therefore, there is a need for a device and method capable of preventing a passenger from manipulating a touch display or tampering with driver's settings in a vehicle without driver's permission.

### SUMMARY

It is an aspect of the present disclosure to provide a vehicle user detection device and method using a touch signal to distinguish a user of an in-vehicle touch display without any additional devices.

In accordance with one aspect of the present disclosure, a vehicle user detection method using a touch signal includes:
applying a touch driving signal to a touch display installed in a vehicle;
injecting a driver touch signal having a first predetermined phase into a driver of the vehicle;
injecting a passenger touch signal having a second predetermined phase into a passenger of the vehicle;
calculating touch voltages of the touch display caused by the driver touch signal and the passenger touch signal;
determining whether the touch display is touched by the passenger by comparing the touch voltage of the touch display caused by the passenger touch signal with a reference touch voltage; and
restricting access to the touch display by the passenger.

Preferably, the first predetermined phase is in-phase with the touch driving signal and the second predetermined phase is out-of-phase with the touch driving signal.

Preferably, the driver touch signal is injected through a steering wheel of the vehicle and the passenger touch signal is injected through a passenger seat of the vehicle.

Preferably, the reference touch voltage is a touch voltage of the touch display obtained in the absence of injection of the passenger touch voltage into the passenger.

Preferably, the touch voltage of the touch display caused by the driver touch signal is less than the reference touch voltage and the touch voltage of the touch display caused by the passenger touch signal is greater than the reference touch voltage.

Preferably, a time interval for injecting the driver touch signal into the driver and a time interval for injecting the passenger touch signal into the passenger do not overlap.

In accordance with another aspect of the present disclosure, a vehicle user detection device using a touch signal includes:
a touch driving signal application unit configured to apply a touch driving signal to a touch display installed in a vehicle;
a driver touch signal injection unit configured to inject a driver touch signal having a first predetermined phase into a driver of the vehicle;
a passenger touch signal injection unit configured to inject a passenger touch signal having a second predetermined phase into a passenger of the vehicle;
a touch voltage calculation unit configured to calculate touch voltages of the touch display caused by the driver touch signal and the passenger touch signal;
a passenger touch determination unit configured to determine whether the touch display is touched by the passenger by comparing the touch voltage of the touch display caused by the passenger touch signal with a reference touch voltage; and
a passenger access restriction unit configured to restrict access to the touch display by the passenger.

Preferably, the first predetermined phase is in-phase with the touch driving signal and the second predetermined phase is out-of-phase with the touch driving signal.

Preferably, the driver touch signal injection unit is mounted within the steering wheel of the vehicle and the passenger touch signal injection unit is mounted on a passenger seat of the vehicle.

Preferably, the reference touch voltage is a touch voltage of the touch display obtained in the absence of injection of the passenger touch voltage into the passenger.

Preferably, the touch voltage of the touch display caused by the driver touch signal is less than the reference touch voltage and the touch voltage of the touch display caused by the passenger touch signal is greater than the reference touch voltage.

Preferably, a time interval for injecting the driver touch signal into the driver and a time interval for injecting the passenger touch signal into the passenger do not overlap.

Embodiments of the present disclosure provide a vehicle user detection device and method using a touch signal, which can distinguish a user of a touch display installed in a vehicle without additional devices, such as sensors or cameras.

Embodiments of the present disclosure provide a vehicle user detection device and method using a touch signal, which can allow only a driver to access the touch display, thereby promoting driving safety.

### BRIEF DESCRIPTION OF THE DRAWINGS

The above and other aspects, features, and advantages of the present disclosure will become apparent from the detailed description of the following embodiments in conjunction with the accompanying drawings:

FIG. 1 is a flowchart illustrating a vehicle user detection method using a touch signal according to an embodiment of the present disclosure;

FIG. 2 is a conceptual diagram illustrating principles of the vehicle user detection method using a touch signal according to the embodiment of the present disclosure;

FIG. 3 is a graph showing a reference touch voltage, a touch voltage caused by a driver touch signal, and a touch voltage caused by a passenger touch signal;

FIG. 4A is a diagram illustrating a process in which a driver touch signal is injected into a driver through a steering wheel of a vehicle;

FIG. 4B is a schematic diagram of waveforms of driver touch signals from the driver's left and right hands;

FIG. 5 is a schematic diagram of a vehicle user detection device using a touch signal according to an embodiment of the present disclosure; and

FIG. 6 is a diagram illustrating additional embodiments of a method of injecting a driver touch signal or a passenger touch signal in the vehicle user detection device and method according to the present disclosure.

### DETAILED DESCRIPTION OF EMBODIMENTS

Hereinafter, exemplary embodiments of the present disclosure will be described with reference to the accompanying drawings.

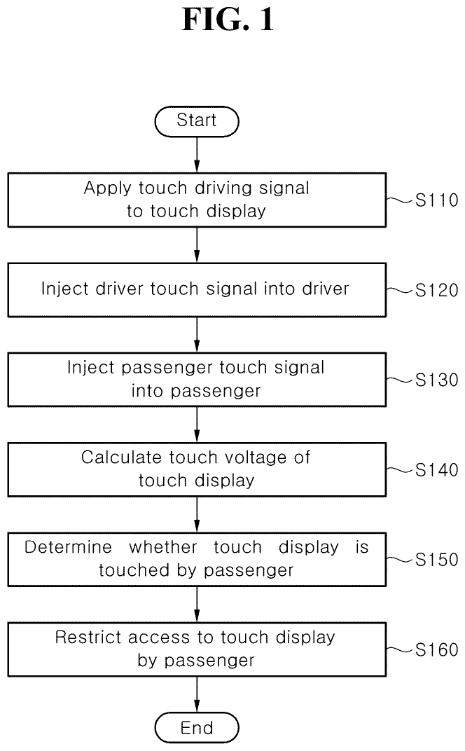

FIG. 1 is a flowchart illustrating a vehicle user detection method using a touch signal according to an embodiment of the present disclosure.

A touch sensing method of a vehicular touch display used in the present disclosure adopts a self-dot sensing method. The self-dot sensing method uses self-capacitance. That is, one touch sensor generates inherent touch capacitance in response to being touched by a user finger or the like.

Generally, touch sensors are arranged in a matrix with a plurality of rows and a plurality of columns on a touchscreen or a touch panel, which is integrated into an upper or lower part of the vehicular touch display.

In the self-dot sensing method, the presence of a touch by a finger is determined based on a difference between touch voltages in the presence of a touch by the finger and in the absence of a touch by the finger, followed by calculating and outputting touch coordinates.

As compared with a touch voltage in the absence of a touch on a touch display by the finger, the presence of a touch on the touch display by the finger causes a change (for example, increase) in touch voltage due to change in capacitance through addition of a touch capacitor Ct connected to the ground when the touch display is touched by the touch sensor. That is, change in capacitance causes change in touch voltage.

A vehicle user detection method using a touch signal according to one embodiment of the present disclosure includes applying a touch driving signal to a touch display installed in a vehicle (S110).

The touch driving signal is applied on a row-by-row or column-by-column basis to a touch panel integrated into the touch display at regular intervals in order to detect whether the touch display is touched by a finger.

In Step S120, a driver touch signal having a first predetermined phase is injected into a driver of the vehicle.

In one embodiment, the first predetermined phase is in-phase with the touch driving signal.

In one embodiment, the driver touch signal is injected through a steering wheel of the vehicle.

In Step S130, a passenger touch signal having a second predetermined phase is injected into a passenger of the vehicle.

In one embodiment, the second predetermined phase is out-of-phase with the touch driving signal.

In one embodiment, the passenger touch signal is injected through a passenger seat of the vehicle.

When a square wave signal synchronized with the touch driving signal applied to the touch display is injected into the driver or the passenger, a potential of the finger changes according to the square wave signal rather than the ground.

As a result, as compared with a normal touch without injection of the square wave signal synchronized with the touch driving signal, there occurs a significant signal difference, in which the touch voltage varies depending on the signal phase.

A signal in-phase with the touch driving signal outputs a lower touch signal relative to a normal touch and a signal out-of-phase with the touch driving signal is formed and output by raising the touch signal.

Touch voltage tendency differs depending on whether the injected signal is in-phase or out-of-phase and it can be determined whether the driver or the passenger has touched the touch display, after determining the touch voltage tendency.

Herein, the signal in-phase with the touch driving signal will be referred to as “in-phase touch signal” and the signal out-of-phase with the touch driving signal will be referred to as “out-of-phase touch signal”.

In Step S140, touch voltages of the touch display caused by the driver touch signal and the passenger touch signal are calculated.

The touch voltages of the touch display caused by the driver touch signal and the passenger touch signal are calculated by the aforementioned self-dot method.

In Step S150, a touch on the touch display by the passenger is determined by comparing the touch voltage of the touch display caused by the passenger touch signal with a reference touch voltage.

In one embodiment, the reference touch voltage is a touch voltage of the touch display obtained when no passenger touch signal is applied to the passenger.

The touch voltage of the touch display caused by the driver touch signal in-phase with the touch driving signal is less than the reference touch voltage and the touch voltage of the touch display caused by the passenger touch signal out-of-phase with the touch driving signal is greater than the reference touch voltage.

A significant difference in signal characteristics between a touch by the driver and a touch by the passenger can be generated by inputting an in-phase touch signal to the driver and an out-of-phase touch signal to the passenger, thereby improving subject discrimination reliability.

In Step S160, access to the touch display by the passenger is restricted.

In order to limit operation of the touch display in the vehicle to the driver, a touch by the passenger is restricted. According to this embodiment, touch signals with different phases are injected into the driver and the passenger, respectively, in order to implement this feature.

In another embodiment, in a certain region of the touch display of the vehicle, a touch by the driver is restricted and operation of the touch display is limited only to the passenger.

By injecting the touch signals with different phases, the difference in touch voltage of the touch display between the driver and the passenger is further amplified.

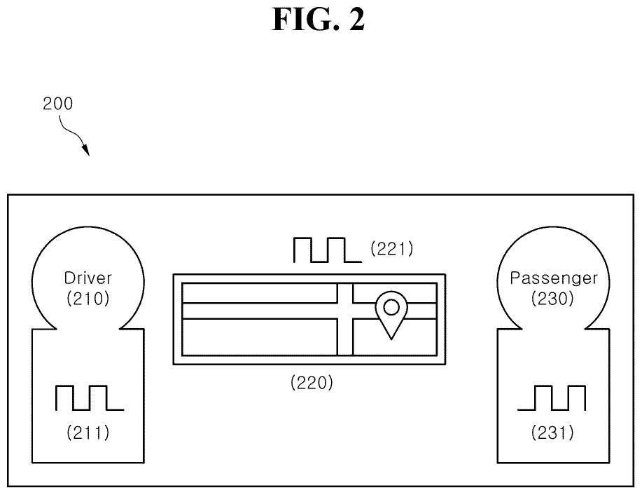

FIG. 2 is a conceptual diagram illustrating principles of the vehicle user detection method using a touch signal according to the embodiment of the present disclosure.

Referring to FIG. 2, touch signals with different phases are applied to a driver 210 and a passenger 230 to detect a user of the touch display.

A touch display 220 disposed in a vehicle 200 is provided with a touchscreen formed with a plurality of touch sensors.

A driving signal 221 is applied to the touch display 220 for touch detection on the touch display.

At the same time, a driver touch signal 211 in-phase with the driving signal is injected into the driver.

In addition, a passenger touch signal 231 out-of-phase with the driving signal is injected into the passenger.

A touch voltage of the touch display caused by the driver touch signal in-phase with the touch driving signal is less than the reference touch voltage, and a touch voltage of the touch display caused by the passenger touch signal out-of-phase with the touch driving signal is greater than the reference touch voltage.

As mentioned above, the reference touch voltage is a touch voltage of the touch display obtained through a touch by the driver in the absence of injection of the driver touch signal to the driver or through a touch by the passenger in the absence of injection of the passenger touch signal to the passenger.

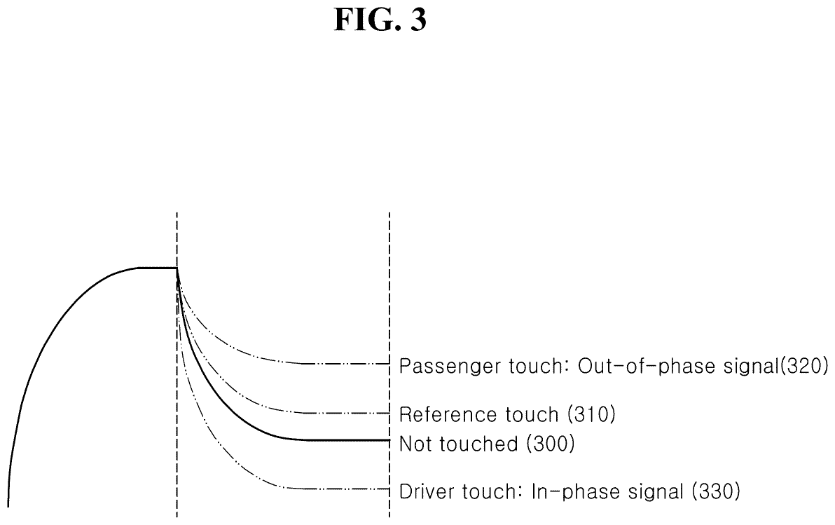

FIG. 3 is a graph showing a reference touch voltage, a touch voltage caused by a driver touch signal, and a touch voltage caused by a passenger touch signal.

Referring to FIG. 3, a touch voltage 330 of the touch display caused by a driver touch signal in-phase with a touch driving signal is less than a reference touch voltage 310.

Conversely, a touch voltage 320 of the touch display caused by a passenger touch signal out-of-phase with the touch driving signal is greater than the reference touch voltage 310. The reference touch voltage is a touch voltage of the touch display obtained through a touch by the driver in the absence of injection of the driver touch signal into the driver or through a touch by the passenger in the absence of injection of the passenger touch signal into the passenger.

When touch capacitance is generated through a touch by a finger, the touch voltage is greater than a touch voltage when there is no touch (300).

A signal in-phase with the touch driving signal is a negative signal relative to normal touch and a signal out of phase with the touch driving signal is a positive touch signal relative to the normal touch.

The reference touch voltage may be calculated according to Equation 1:

$$Normal Touch ( mV ) = Vdrv \frac{Cp + Cdrv}{( Cdrv + Cp + {Cp}^{′} + Cd )} - Vdrv \frac{Cp + Cdrv}{( Cdrv + Cp + {Cp}^{′} + Cd + Ct )} , \qquad ( 1 )$$

where Vdrv denotes a driving voltage applied to the touch display, Cp denotes a capacitor between sensors, Cdrv denotes an IC internal capacitor to improve driving back sensing sensitivity, Cp′ denotes an IC parasitic capacitor, Cd denotes a capacitor between a sensor and the touch display, and Ct denotes a capacitor between the sensor and a touch object.

Equation 1 is the formula for calculating the reference touch voltage and may be obtained by subtracting a voltage with a touch from a voltage without a touch, with the driving voltage applied to the touch display.

The touch voltage of the touch display caused by the driver touch signal in-phase with the touch driving signal may be calculated according to Equation 2:

$$( ⌉ ) Driving Touch ( mV ) = Vdrv \frac{Cp + Cdrv}{( Cdrv + Cp + {Cp}^{′} + Cd )} - Vdrv \frac{Cp + Cdrv + Ct}{( Cdrv + Cp + {Cp}^{′} + Cd + Ct )} , \qquad ( 2 )$$

The touch voltage of the touch display caused by the passenger touch signal out-of-phase with the touch driving signal may be calculated according to Equation 3:

$$( ⌊ ) Reverse Driving Touch ( mV ) = Vdrv \frac{Cp + Cdrv}{( Cdrv + Cp + {Cp}^{′} + Cd )} - Vdrv \frac{Cp + Cdrv - Ct}{( Cdrv + Cp + {Cp}^{′} + Cd - Ct )} , \qquad ( 3 )$$

As can be seen from Equation 2, a larger value due to a positive touch capacitance (Ct) is subtracted from the touch voltage of the touch display caused by the driver touch signal in-phase with the touch driving signal, thereby providing a smaller overall touch voltage.

In contrast, as can be seen from Equation 3, a smaller value due to a negative touch capacitance (Ct) is subtracted from the touch voltage of the touch display caused by the passenger touch signal out-of-phase with the touch driving signal, thereby providing a larger overall touch voltage.

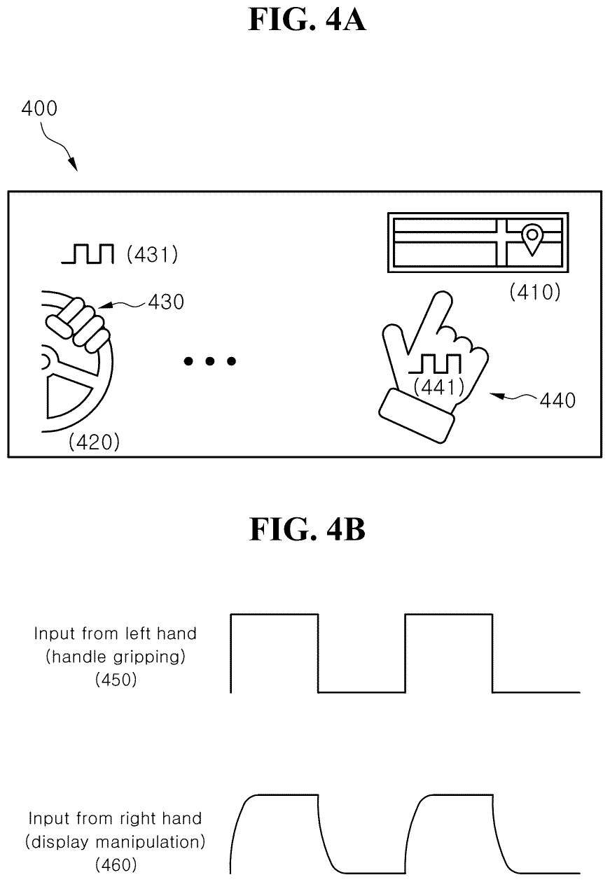

FIG. 4A is a diagram illustrating a process in which a driver touch signal is injected into a driver through a steering wheel of a vehicle.

FIG. 4A illustrates an example where the driver touch signal is injected when the driver grasps the steering wheel 420 of the vehicle.

When the driver touch signal 431 is output from the steering wheel at the same timing as the driving signal, the driver touch signal is injected into the left hand 430 of the driver.

At the same time, an in-phase driver touch signal 441 is injected into the right hand 440 of the driver.

FIG. 4B is a schematic diagram of waveforms of driver touch signals input from the driver's left and right hands.

As shown in FIG. 4B, the driver touch signals 431 input from the left and right hands of the driver have the same phase signal waveforms.

However, it can be seen that, on the right hand trying to operate the touch display, voltage loss and reduction in waveform slope occur due to resistance in the body of the driver.

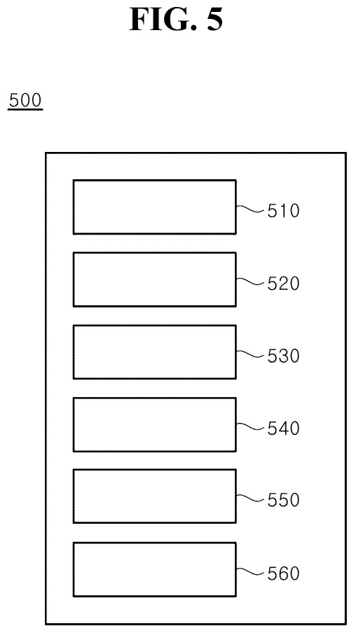

FIG. 5 is a schematic diagram of a vehicle user detection device using a touch signal according to an embodiment of the present disclosure.

A vehicle user detection device using a touch signal according to an embodiment of the present disclosure includes: a touch driving signal application unit 510 configured to apply a touch driving signal to a touch display installed in a vehicle; a driver touch signal injection unit 520 configured to inject a driver touch signal having a first predetermined phase into a driver of the vehicle; a passenger touch signal injection unit 530 configured to inject a passenger touch signal having a second predetermined phase into a passenger of the vehicle; a touch voltage calculation unit 540 configured to calculate touch voltages of the touch display caused by the driver touch signal and the passenger touch signal; a passenger touch determination unit 550 configured to determine whether the touch display is touched by the passenger by comparing the touch voltage of the touch display caused by the passenger touch signal with a reference touch voltage; and a passenger access restriction unit 560 configured to restrict access to the touch display by the passenger.

In one embodiment, the touch driving signal application unit 510, the touch voltage calculation unit 540, the passenger touch determination unit 550, and the passenger access restriction unit 560 may be embedded in a touch IC (integrated circuit) of a touch panel.

The touch IC may determine the presence or absence of a touch signal and calculate touch coordinates.

According to this embodiment, in order to further amplify a difference between the touch voltage by the driver and the touch voltage by the passenger, the first predetermined phase may be in-phase with the touch driving signal and the second predetermined phase may be out-of-phase with the touch driving signal.

In one embodiment, the driver touch signal injection unit 520 is mounted within a steering wheel of the vehicle and the passenger touch signal injection unit 530 is mounted on a passenger seat of the vehicle.

In one embodiment, the reference touch voltage is a touch voltage of the touch display obtained in the absence of any injection of the passenger touch voltage into the passenger.

The reference touch voltage may be calculated according to Equation 1.

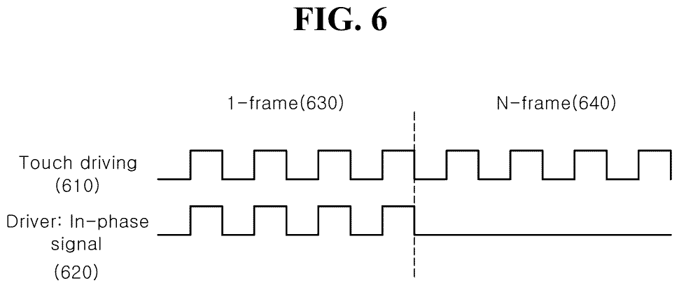

FIG. 6 is a diagram illustrating additional embodiments of a method of injecting a driver touch signal or a passenger touch signal in the vehicle user detection device and method according to the present disclosure.

FIG. 6 shows one example of a method of injecting a driver touch signal or a passenger touch signal, which can reduce EMI effects by externally applied signals.

In one embodiment, a time interval for injecting the driver touch signal into the driver and as time interval for injecting the passenger touch signal into the passenger may be set so as not to overlap each other.

As shown in FIG. 6, the time interval for injecting the driver touch signal into the driver corresponds to a 1-frame 630. Although not specifically shown in FIG. 6, the time interval for injecting the passenger touch signal into the passenger corresponds to another time frame that does not overlap the 1-frame interval 630.

When the touch driving signal is applied to the driver or the passenger only for a specific time frame, it is possible to distinguish a touch subject between the driver and the passenger by determining the touch signal value for the specific time frame.

The present invention may be applied to other components of an automobile having similar branching frequencies not only by touch operation but also through synchronization.

Although the present disclosure has been described with reference to some embodiments in conjunction with the accompanying drawings, the present disclosure is not limited thereto. It will be apparent to a person having ordinary knowledge in the art that various modifications, changes, alterations, and equivalent embodiments can be made without departing from the spirit and scope of the present disclosure.

1. A vehicle user detection method using a touch signal, comprising:
applying a touch driving signal to a touch display installed in a vehicle;
injecting a driver touch signal having a first predetermined phase into a driver of the vehicle;
injecting a passenger touch signal having a second predetermined phase into a passenger of the vehicle;
calculating touch voltages of the touch display caused by the driver touch signal and the passenger touch signal;
determining whether the touch display is touched by the passenger by comparing the touch voltage of the touch display caused by the passenger touch signal with a reference touch voltage; and
restricting access to the touch display by the passenger.

2. The vehicle user detection method according to claim 1, wherein the first predetermined phase is in-phase with the touch driving signal and the second predetermined phase is out-of-phase with the touch driving signal.

3. The vehicle user detection method according to claim 2, wherein the driver touch signal is injected through a steering wheel of the vehicle and the passenger touch signal is injected through a passenger seat of the vehicle.

4. The vehicle user detection method according to claim 2, wherein the reference touch voltage is a touch voltage of the touch display obtained when no passenger touch signal is applied to the passenger.

5. The vehicle user detection method according to claim 4, wherein the touch voltage of the touch display caused by the driver touch signal which is in-phase with the touch driving signal is less than the reference touch voltage and the touch voltage of the touch display caused by the passenger touch signal which is out-of-phase with the touch driving signal is greater than the reference touch voltage.

6. The vehicle user detection method according to claim 1, wherein a time interval for injecting the driver touch signal into the driver and a time interval for injecting the passenger touch signal into the passenger do not overlap.

7. A vehicle user detection device using a touch signal, comprising:
a touch driving signal application unit configured to apply a touch driving signal to a touch display installed in a vehicle;
a driver touch signal injection unit configured to inject a driver touch signal having a first predetermined phase into a driver of the vehicle;
a passenger touch signal injection unit configured to inject a passenger touch signal having a second predetermined phase into a passenger of the vehicle;
a touch voltage calculation unit configured to calculate touch voltages of the touch display caused by the driver touch signal and the passenger touch signal;
a passenger touch determination unit configured to determine whether the touch display is touched by the passenger by comparing the touch voltage of the touch display caused by the passenger touch signal with a reference touch voltage; and
a passenger access restriction unit configured to restrict access to the touch display by the passenger.

8. The vehicle user detection device according to claim 7, wherein the first predetermined phase is in-phase with the touch driving signal and the second predetermined phase is out-of-phase with the touch driving signal.

9. The vehicle user detection device according to claim 8, wherein the driver touch signal injection unit is mounted within a steering wheel of the vehicle and the passenger touch signal injection unit is mounted on a passenger seat of the vehicle.

10. The vehicle user detection device according to claim 8, wherein the reference touch voltage is a touch voltage of the touch display obtained in the absence of injection of the passenger touch voltage into the passenger.

11. The vehicle user detection device according to claim 10, wherein the touch voltage of the touch display caused by the driver touch signal is less than the reference touch voltage, and the touch voltage of the touch display caused by the passenger touch signal is greater than the reference touch voltage.

12. The vehicle user detection device according to claim 7, wherein a time interval for injecting the driver touch signal into the driver and a time interval for injecting the passenger touch signal into the passenger do not overlap.
